(19) United States
(12) Patent Application Publication
(10) Pub. No.: US 2011/0183081 A1
(43) Pub. Date: Jul. 28, 2011

(54) PHOTOCURABLE INK COMPOSITION AND INK JET RECORDING METHOD

(75) Inventors: Hiroki Nakane, Matsumoto-shi (JP); Hiroyuki Kajimoto, Matsumoto-shi (JP); Chigusa Sato, Shiojiri-shi (JP); Taketoshi Kagose, Shiojiri-shi (JP); Jun Ito, Shimosuwa-machi (JP); Hiroaki Kida, Matsumoto-shi (JP); Akira Kooguchi, Shimosuwa-machi (JP); Toru Saito, Minowa-machi (JP); Toshiyuki Miyabayashi, Shiojiri-shi (JP); Hiroyuki Onishi, Matsumoto-shi (JP)

(73) Assignee: Seiko Epson Corporation, Tokyo (JP)

(21) Appl. No.: 13/010,961

(22) Filed: Jan. 21, 2011

(30) Foreign Application Priority Data
Jan. 22, 2010 (JP) 2010-011843

(51) Int. Cl. B05D 5/06; C08F 2/46

(52) U.S. Cl. 427/511; 522/64

(57) ABSTRACT

A photocurable ink composition includes (A) a polymerizable compound, (B) an acylphosphine oxide-based photopolymerization initiator, and (C) at least one compound selected from a hindered amine-based compound with a mass-average molecular weight of 2000 to 4000 and a hydroxyphenyltriazine-based compound of formula (1):

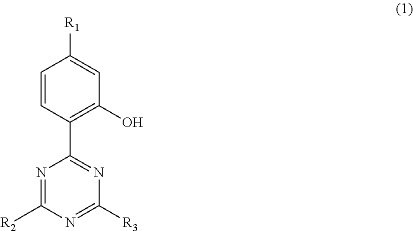

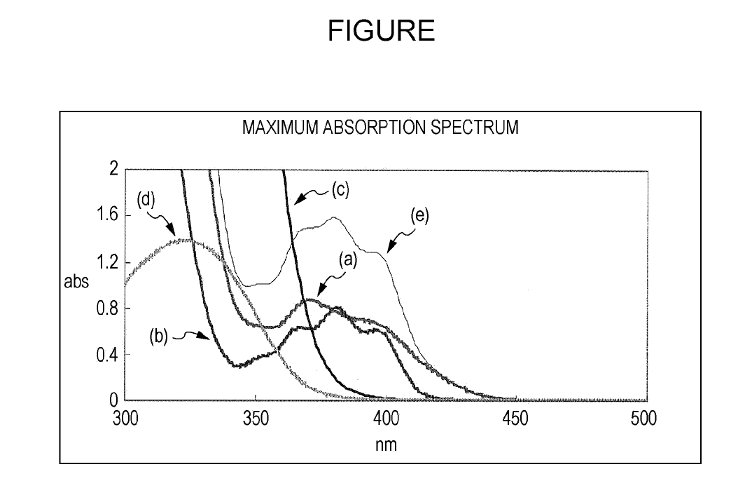

(wherein R₁, R₂, and R₃ each independently represent an organic group). The proportion of the component (C) is in the range of 0.2% by mass to 2.0% by mass.

### BACKGROUND

1. Technical Field

The present invention relates to a photocurable ink composition and an ink jet recording method using the photocurable ink composition.

2. Related Art

In recent years, photocurable ink, which is cured by irradiation with light, such as ultraviolet light, has been being developed. Photocurable ink has a quick drying property. When recording is performed on a nonabsorptive medium, such as plastic, which does not absorb ink, using photocurable ink, ink bleeding is prevented. Photocurable ink contains, for example, a polymerizable compound, a polymerization initiator, and a pigment.

However, in the case where photocurable ink is used for printing on, for example, a nonabsorptive medium, yellowing, discoloration, and so forth can occur because of its insufficient lightfastness. To overcome these problems, for example, JP-A-2006-123459 discloses that the addition of a triazine-based ultraviolet absorbent, a polymer containing a hindered amine-based light stabilizer, and so forth improves lightfastness.

### SUMMARY

However, in the example of the related art described above, a recorded image does not have sufficient lightfastness or curing properties, depending on the types and amounts of the ultraviolet absorbent, the light stabilizer, and so forth, in some cases.

Furthermore, in the example of the related art described above, a component of the ultraviolet absorbent or the light stabilizer can bleed partially on a surface of the recorded image after long-term storage of the recorded image.

An advantage of some aspects of the invention is that it provides a photocurable ink composition in which an image recorded using the photocurable ink composition has excellent lightfastness and curing properties and in which even if the image is stored for long periods, the bleeding of an ultraviolet absorbent and a light stabilizer on the surface of the image are suppressed.

An advantage of some aspects of the invention is that it provides the following aspects and embodiments.

According to a first aspect of the invention, a photocurable ink composition includes (A) a polymerizable compound, (B) an acylphosphine oxide-based photopolymerization initiator, and (C) at least one compound selected from a hindered amine-based compound with a mass-average molecular weight of 2000 to 4000 and a hydroxyphenyltriazine-based compound of formula (1), and the proportion of the component (C) is in the range of 0.2% by mass to 2.0% by mass:

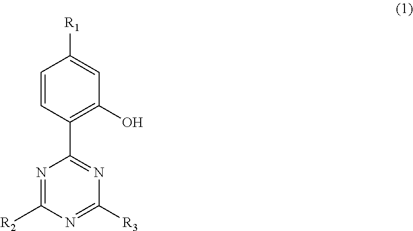

(wherein R₁, R₂, and R₃ each independently represent an organic group).

In the photocurable ink composition according to the first aspect of the invention, a recorded image has excellent lightfastness and curing properties. Furthermore, when the image is stored for long periods, the bleeding of an ultraviolet absorbent and a light stabilizer is prevented.

In the photocurable ink composition according to the first aspect of the invention, the acylphosphine oxide-based photopolymerization initiator preferably has a molar absorption coefficient of 300 or more at 365 nm.

In the photocurable ink composition according to the first aspect of the invention, preferably, the hydroxyphenyltriazine-based compound of formula (1) does not have a maximum absorption wavelength in the range of 350 nm to 430 nm. The acylphosphine oxide-based photopolymerization initiator may have a maximum absorption wavelength of 350 nm to 430 nm. The photocurable ink composition may be cured by irradiation with light having a peak emission wavelength of 350 nm to 430 nm.

In the photocurable ink composition according to the first aspect of the invention, the polymerizable compound may contain at least one selected from phenoxyethyl acrylate, alkylene glycol diacrylate, and diacrylate having a alicyclic structure.

In the photocurable ink composition according to the first aspect of the invention, the acylphosphine oxide-based photopolymerization initiator may have at least one of a phenyl group and benzoyl group in its molecule.

In this case, the acylphosphine oxide-based photopolymerization initiator may be at least one selected from 2,4,6-trimethylbenzoyldiphenylphosphine oxide and bis(2,4,6-trimethylbenzoyl)phenylphosphine oxide.

In the photocurable ink composition according to the first aspect of the invention, the acylphosphine oxide-based photopolymerization initiator content may be in the range of 3% by mass to 15% by mass.

In the photocurable ink composition according to the first aspect of the invention, the polymerizable compound content may be 20% by mass or more.

An ink jet recording method according to a second aspect of the invention includes ejecting the photocurable ink composition according to any one of Claims 1 to 8 onto a recording medium, and irradiating the ejected photocurable ink composition with light having a peak emission wavelength of 350 nm to 430 nm from a light source.

### BRIEF DESCRIPTION OF THE DRAWING

The invention will be described with reference to the accompanying drawings, wherein like numbers reference like elements.

FIGURE illustrates absorption spectra of an ultraviolet absorbent and a polymerization initiator in a photocurable ink composition according to an embodiment of the invention.

### DESCRIPTION OF EXEMPLARY EMBODIMENTS

Preferred embodiments of the invention will be described below. The following embodiments are merely examples of the invention. The invention is not limited to the following embodiments. Various modifications may be made so long as the subject matter of the invention is not changed.

### 1. Photocurable Ink Composition

A photocurable ink composition according to an embodiment of the invention contains (A) a polymerizable compound, (B) an acylphosphine oxide-based photopolymerization initiator, (C) at least one compound selected from a hindered amine-based compound with a mass-average molecular weight of 2000 to 4000 and a hydroxyphenyltriazine-based compound of formula (1):

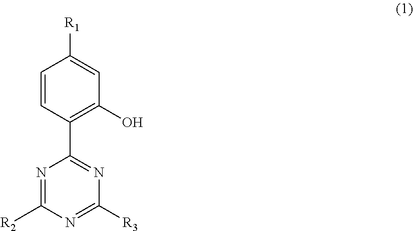

(wherein R₁, R₂, and R₃ each independently represent an organic group),

in which the proportion of the (C) component is in the range of 0.2% by mass to 2.0% by mass. The term “image” used in the invention indicates a printed pattern formed of dots and includes printed characters and solid images.

The photocurable ink composition according to this embodiment will be described in detail below.

### 1.1. Polymerizable Compound

The photocurable ink composition according to this embodiment contains the polymerizable compound serving as the component (A). Examples of the polymerizable compound include monofunctional monomers, difunctional monomers, trifunctional monomers, urethane acrylate oligomers, and amino acrylate described below.

Examples of monofunctional monomers include, but are not particularly limited to, (2-methyl-2-ethyl-1,3-dioxolan-4-yl)methyl (meth)acrylate, (2-methyl-2-isobutyl-1,3-dioxolan-4-yl)methyl (meth)acrylate, phenoxyethyl (meth)acrylate, isobornyl (meth)acrylate, methoxy diethylene glycol mono(meth)acrylate, (meth) acryloylmorpholine, dicyclopentenyloxyethyl (meth)acrylate, dicyclopentenyl (meth)acrylate, dicyclopentanyl (meth)acrylate, isobornyl (meth)acrylate, trimethylolpropaneformal mono(meth)acrylate, adamantyl (meth)acrylate, oxetane (meth)acrylate, and 3,3,5-trimethylcyclohexane (meth)acrylate. These polymerizable compounds may be used alone or in combination. The term “(meth)acrylate” used in this specification indicates acrylate and methacrylate.

Examples of difunctional monomers include, but are not particularly limited to, alkylene glycol di(meth)acrylate and di(meth)acrylate having an alicyclic structure. Examples of alkylene glycol di(meth)acrylate include ethylene glycol di(meth)acrylate, diethylene glycol di(meth)acrylate, tripropylene glycol di(meth)acrylate, 1,9-nonanediol di(meth)acrylate, polyethylene glycol di(meth)acrylate, tetraethylene glycol di(meth)acrylate, 1,6-hexanediol di(meth)acrylate, neopentyl glycol di(meth)acrylate, and 2-hydroxy-1,3-di(meth)acryloxypropane. Examples of di(meth)acrylate having an alicyclic structure include tricyclodecane dimethanol di(meth)acrylate, dioxane glycol di(meth)acrylate, isocyanuric acid EO-modified di(meth)acrylate, dimethyloltricyclodecane di(meth)acrylate, and 1,3-adamantanediol di(meth)acrylate. These polymerizable compounds may be used alone or in combination.

Examples of trifunctional monomers include, but are not particularly limited to, trimethylolpropane tri(meth)acrylate, trimethylolpropane EO-modified tri(meth)acrylate, trimethylolpropane PO-modified tri(meth)acrylate, glycerol PO-modified tri(meth)acrylate, and isocyanuric acid EO-modified tri(meth)acrylate. These polymerizable compounds may be used alone or in combination.

The polymerizable compound may additionally contain an N-vinyl compound. Examples of the N-vinyl compound include N-vinylformamide, N-vinylcarbazole, N-vinylacetamide, N-vinylpyrrolidone, N-vinylcaprolactam, and derivatives thereof.

The polymerizable compound may contain a urethane-based oligomer. The term “urethane-based oligomer” indicates at least one urethane bond and at least one radically polymerizable unsaturated double bond in its molecule. Here, the term “oligomer” used in this embodiment indicates a molecule having moderate relative molecular mass and having a few, typically about two to about 20, repeat units each substantially or conceptually defined by a molecule with low relative molecular mass (synonymous with molecular weight).

Examples of the urethane-based oligomer include oligomers formed by the addition reaction of polyols, polyisocyanates, and polyhydroxy compounds. Examples of the urethane-based oligomer include polyester-based urethane acrylates, polyether-based urethane acrylates, polybutadiene-based urethane acrylates, and polyol-based urethane acrylates. Specific examples of the urethane-based oligomer include CN963J75, CN964, CN965, and CN966J75 (all available from Sartomer).

The polymerizable compound may contain amino acrylate. Examples of the amino acrylate include products formed by allowing difunctional (meth)acrylates to react with amine compounds.

Examples of the difunctional acrylate include alkylene glycol di(meth)acrylates, such as propylene glycol di(meth)acrylate, 1,3-butylene glycol di(meth)acrylate, 1,4-butanediol di(meth)acrylate, 1,6-hexanediol di(meth)acrylate, 1,9-nonanediol di(meth)acrylate, and neopentyl glycol di(meth)acrylate; di(meth)acrylates of alkylene oxide adducts of bisphenol, such as di(meth)acrylate of an ethylene oxide adduct of bisphenol S, di(meth)acrylate of an ethylene oxide adduct of bisphenol F, di(meth)acrylate of an ethylene oxide adduct of bisphenol A, di(meth)acrylate of an ethylene oxide adduct of thiobisphenol, and di(meth)acrylate of an ethylene oxide adduct of brominated bisphenol A; polyalkylene glycol di(meth)acrylates, such as polyethylene glycol di(meth)acrylate and polypropylene glycol di(meth)acrylate; and di(meth)acrylate of neopentyl glycol hydroxypivalate.

Examples of amine compounds include monofunctional amine compounds, such as ethylamine, n-propylamine, isopropylamine, n-butylamine, isobutylamine, n-pentylamine, isopentylamine, n-hexylamine, cyclohexylamine, n-heptylamine, n-octylamine, 2-ethylhexylamine, n-nonylamine, n-decylamine, n-dodecylamine, n-tetradecylamine, n-hexadecylamine, n-octadecylamine, benzylamine, and phenethylamine; and polyfunctional amine compounds, such as diethylenetriamine, triethylenetetramine, tetraethylenepentamine, 1,6-hexamethylenediamine, 1,8-octamethylenediamine, 1,12-dodecamethylenediamine, o-phenylenediamine, p-phenylenediamine, m-phenylenediamine, o-xylylenediamine, p-xylylenediamine, m-xylylenediamine, menthanediamine, bis(4-amino-3-methylcyclohexylmethane, 1,3-diaminocyclohexane, isophorone diamine, and spiroacetal-based diamine. Furthermore, high-molecular-weight polyfunctional amine compounds, such as polyethyleneimine, polyvinylamine, and polyallylamine, may be exemplified.

Among these polymerizable compounds described above, phenoxyethyl acrylate is preferably used because phenoxyethyl acrylate has excellent compatibility with an acylphosphine oxide-based photopolymerization initiator described below and an image formed on a recording medium has excellent curing properties and flexibility.

The polymerizable compound content is preferably 20% by mass or more and more preferably 20% by mass to 95% by mass with respect to the total mass of the photocurable ink composition. A polymerizable compound content of 20% by mass or more results in satisfactory curing properties of an image formed on a recording medium. A polymerizable compound content of less than 20% by mass can lead to insufficient curing properties of an image formed on a recording medium.

In the case where phenoxyethyl acrylate is used as the polymerizable compound, more preferably, at least one selected from alkylene glycol diacrylate and diacrylate having an alicyclic structure is further used. Alkylene glycol diacrylate and diacrylate having an alicyclic structure function as crosslinking agents to improve the film strength of an image formed on a recording medium. In particular, diacrylate having an alicyclic structure has a bulky molecular structure and thus effectively improves the film strength of an image.

### 1.2. Photopolymerization Initiator

The photocurable ink composition according to this embodiment contains an acylphosphine oxide-based photopolymerization initiator serving as the component (B). The acylphosphine oxide-based photopolymerization initiator is excited by absorbing light, thereby generating a radical by intramolecular cleavage. This initiates the polymerization reaction of the polymerizable compound.

Furthermore, an initiator residue formed by the intramolecular cleavage of the acylphosphine oxide-based photopolymerization initiator does not absorb light and thus does not prevent the transmission of light to the inside of an image formed on a recording medium, i.e., the initiator residue has what is called a photobleaching effect. So, light reaches the inside of the image formed on the recording medium, thereby improving the curing properties of the image.

The acylphosphine oxide-based photopolymerization initiator preferably has a molar absorption coefficient of 300 or more at 365 nm. In the case where the acylphosphine oxide-based photopolymerization initiator has a molar absorption coefficient of 300 or more at 365 nm, even if an ultraviolet LED (e.g., a light source with a peak emission wavelength of, for example, 365 nm or 395 nm) that emits light having relatively low energy is used, intramolecular cleavage can be successfully performed, thus initiating the polymerization reaction of the polymerizable compound.

The term “molar absorption coefficient” indicates the degree of absorption of light having a given wavelength by a substance. The molar absorption coefficient of the acylphosphine oxide-based photopolymerization initiator can be determined by measuring the absorbance of a solution of the acylphosphine oxide-based photopolymerization initiator in acetonitrile at 365 nm with a spectrophotometer U-3300 (manufactured by Hitachi High-Technologies Corporation) and performing calculation according to the Lambert-Beer law.

The acylphosphine oxide-based photopolymerization initiator preferably has a maximum absorption wavelength of 350 nm to 430 nm. The acylphosphine oxide-based photopolymerization initiator having a maximum absorption wavelength within the foregoing range has excellent light absorption properties compared with a photopolymerization initiator having a maximum absorption wavelength outside the range described above. For the acylphosphine oxide-based photopolymerization initiator having a maximum absorption wavelength within the foregoing range, even the use of the ultraviolet LED described above successfully results in intramolecular cleavage to initiate the polymerization reaction of the polymerizable compound. The ultraviolet LED preferably has a peak emission wavelength of 350 nm to 430 nm.

The term “maximum absorption wavelength” used in this specification does not indicate a wavelength at which maximum absorption is observed but indicates a maximum value within a specific wavelength range (for example, the maximum value of (a) in the range of 350 nm to 430 nm illustrated in FIGURE).

The acylphosphine oxide-based photopolymerization initiator preferably has at least one selected from a phenyl group and a benzoyl group, in its molecule. More preferably, the acylphosphine oxide-based photopolymerization initiator has both the phenyl group and the benzoyl group.

Examples of the acylphosphine oxide-based photopolymerization initiator having both the phenyl group and the benzoyl group in its molecule include 2,4,6-trimethylbenzoyldiphenylphosphine oxide and bis(2,4,6-trimethylbenzoyl)phenylphosphine oxide. These compounds may be used alone or in combination. These photopolymerization initiators can be particularly preferably used because, for example, they have excellent photobleaching effect, excellent compatibility with the polymerizable compound, and a molar absorption coefficient of 300 or more at 365 nm.

A specific example of 2,4,6-trimethylbenzoyldiphenylphosphine oxide is DAROCUR TPO (trade name, manufactured by Ciba Japan K.K). A specific example of bis(2,4,6-trimethylbenzoyl)phenylphosphine oxide is IRGACURE 819 (trade name, manufactured by Ciba Japan K.K).

The proportion of the acylphosphine oxide-based photopolymerization initiator is preferably in the range of 3% by mass to 15% by mass and more preferably 7% by mass to 13% by mass with respect to the total mass of the photocurable ink composition. In the case where the proportion of the acylphosphine oxide-based photopolymerization initiator is within the foregoing range, an image formed on a recording medium has satisfactory curing properties. At a proportion of less than the range described above, an image formed on a recording medium can be less likely to be cured. A proportion exceeding the range described above can cause blocking and so forth.

### 1.3. Ultraviolet Absorbent and Light Stabilizer

The photocurable ink composition according to this embodiment contains, as the component (C), at least one compound selected from a hydroxyphenyltriazine-based compound of formula (1) described below and a hindered amine-based compound with a mass-average molecular weight of 2000 to 4000.

The hydroxyphenyltriazine-based compound is a compound of formula (1) (hereinafter, also referred to simply as a “hydroxyphenyltriazine-based compound) and is preferably a compound of formula (2) described below. The hydroxyphenyltriazine-based compound functions as an ultraviolet absorbent that absorbs light, such as ultraviolet rays, to generate vibrational energy, thermal energy, or the like. Thus, the addition of the hydroxyphenyltriazine-based compound to the photocurable ink composition reduces, for example, the deterioration and the discoloration of an image formed on a recording medium.

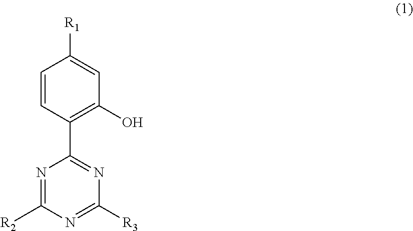

(wherein R₁, R₂, and R₃ each independently represent a monovalent organic group).

In formula (1), R₁, R₂, and R₃ each independently represent a monovalent organic group. Examples of the monovalent organic group include aliphatic hydrocarbons and aromatic hydrocarbons. The monovalent organic group may have an ester bond or an ether bond in its molecular chain.

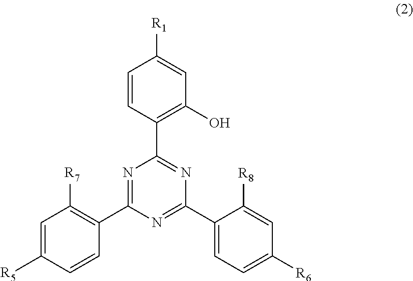

(wherein R₄, R₅, R₆, R₇, and R₈ each independently represent a monovalent organic group, a hydroxy group, or hydrogen).

In formula (2), R₄, R₅, R₆, R₇, and R₈ each independently represent a monovalent organic group, a hydroxy group, or hydrogen. Examples of the monovalent organic group include aliphatic hydrocarbons and aromatic hydrocarbons. The monovalent organic group may have an ester bond or an ether bond in its molecular chain.

The hydroxyphenyltriazine-based compound has the function of absorbing light, such as ultraviolet rays as described above. Thus, if the hydroxyphenyltriazine-based compound readily absorbs light emitted from a light source of an ink jet recording apparatus, the curing properties of an image can be markedly inhibited. So, more preferably, the hydroxyphenyltriazine-based compound is less likely to absorb a light component at and near the peak emission wavelength of light emitted from a light source of an ink jet recording apparatus. For this reason, in the case of using the acylphosphine oxide-based photopolymerization initiator that is likely to absorb the light component at and near the peak emission wavelength of light emitted from the light source of the ink jet recording apparatus, an image is efficiently cured.

For example, in the case where an ultraviolet LED is used as a light source of an ink jet recording apparatus, preferably, the hydroxyphenyltriazine-based compound does not have a maximum absorption wavelength in the range of 380 nm to 400 nm and more preferably 350 nm to 430 nm. The hydroxyphenyltriazine-based compound having a maximum absorption wavelength outside the range described above reduces the absorption of the light component at and near the peak emission wavelength of light emitted from the ultraviolet LED, thereby sufficiently ensuring the curing properties of an image.

If the maximum absorption wavelength of the hydroxyphenyltriazine-based compound is within the range described above, the energy of light used for the photopolymerization initiator is liable to be consumed by the hydroxyphenyltriazine-based compound, thereby possibly reducing the curing properties of an image formed on a recording medium. Furthermore, if the maximum absorption wavelength of the hydroxyphenyltriazine-based compound is within the range described above, it is necessary to increase the cumulative amount of light with which an image is irradiated, in order to provide sufficient curing properties.

Examples of the hydroxyphenyltriazine-based compound include TINUVIN 400, TINUVIN 405, TINUVIN 460, and TINUVIN 479 (trade name, manufactured by Ciba Japan K.K.) having the structure of formula (2). Among these compounds, TINUVIN 479 of formula (3) described below is preferred because of the low absorption of a light component at and near the peak emission wavelength of light emitted from an ultraviolet LED, excellent long life, excellent heat resistance, and so forth.

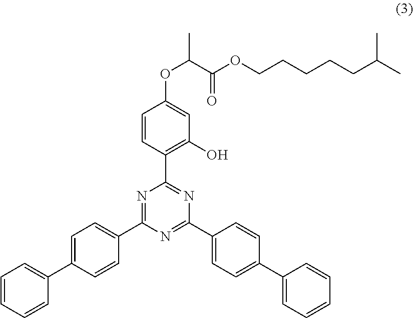

The hindered amine-based compound contained in the photocurable ink composition according to this embodiment has a mass-average molecular weight of 2000 to 4000. The hindered amine-based compound functions as what is called a light stabilizer that traps, for example, a free radical and is bonded thereto.

A free radical generated by light, such as ultraviolet rays can cause the discoloration, deterioration, and the like of an image formed on a recording medium. Thus, the addition of the hindered amine-based compound reduces the deterioration and discoloration of the image by light.

The hindered amine-based compound according to this embodiment has a mass-average molecular weight of 2000 to 4000. In the case where the hindered amine-based compound has a mass-average molecular weight within the range described above, the curing of an image formed on a recording medium is not inhibited, and it is possible to reduce the discoloration of the image and the bleeding of the light stabilizer on the surface of the image when the image is stored for long periods.

The hindered amine-based compound according to this embodiment has a relatively high mass-average molecular weight of 2000 to 4000 and thus is less likely to evaporate into air after the formation of an image, thereby providing the satisfactory radical-trapping function.

The hindered amine-based compound having a mass-average molecular weight outside the range described above can reduce the curing properties of an image formed on a recording medium and can cause the discoloration of the image and the bleeding of the light stabilizer on the surface of the image when the image is stored for long periods.

The mass-average molecular weight can be determined by, for example, performing measurement by gel permeation chromatography (GPC) using tetrahydrofuran as a solvent and calculating an average molecular weight in terms of polystyrene.

The hindered amine-based compound having a mass-average molecular weight of 2000 to 4000 according to this embodiment preferably has a molecular structure of formula (4) described below. While the radical-trapping mechanism of the hindered amine-based compound is still unclear, it is believed that a free radical is trapped at the site of the nitrogen atom in the structure of formula (4).

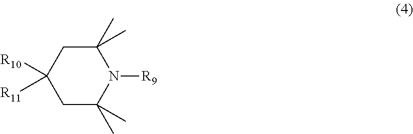

(wherein R₉ represents hydrogen or a mono- or di-valent organic group; and R₁₀ and R₁₁ each independently represent hydrogen, an amino group, or a mono- or di-valent organic group).

In formula (4), R₉ represents hydrogen or a mono- or di-valent organic group. Examples of the mono- or di-valent organic group include aliphatic hydrocarbons and aromatic hydrocarbons. The mono- or di-valent organic group may have an ester bond or an ether bond in its molecular chain.

In formula (4), R₁₀ and R₁₁ each independently represent hydrogen, an amino group, or a mono- or di-valent organic group. Examples of the mono- or di-valent organic group include aliphatic hydrocarbons and aromatic hydrocarbons. The mono- or di-valent organic group may have an ester bond or an ether bond in its molecular chain.

Examples of the hindered amine-based compound having a mass-average molecular weight of 2000 to 4000 according to this embodiment include CHIMASSORB 944FDL (trade name, manufactured by Ciba Japan K.K., mass-average molecular weight: 2000 to 3100) represented by formula (5); and TINUVIN 622LD (trade name, manufactured by Ciba Japan K.K., mass-average molecular weight: 3100 to 4000) represented by formula (6). These compounds are less likely to bleed after the formation of an image on a recording medium and has excellent compatibility with the polymerizable compound described above; hence, these compounds are preferably used.

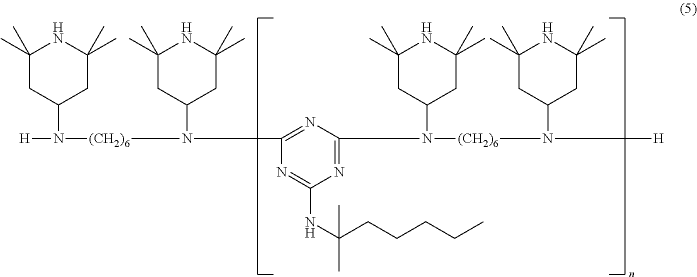

(wherein n represents an integer of 1 or more).

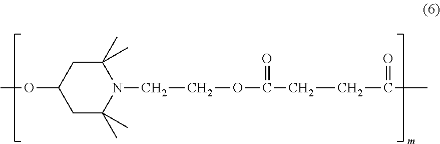

(wherein m represents an integer of 1 or more).

In the case where only the hydroxyphenyltriazine-based compound is contained as the component (C), the proportion of the hydroxyphenyltriazine-based compound is in the range of 0.2% by mass to 2.0% by mass with respect to the total mass of the photocurable ink composition. In the case where the proportion of the hydroxyphenyltriazine-based compound is within the range described above, the curing of an image formed on a recording medium is not inhibited, and it is possible to reduce, for example, the discoloration of the image and the bleeding of the ultraviolet absorbent on the surface of the image when the image is stored for long periods. In the case where the proportion of the hydroxyphenyltriazine-based compound is less than the range described above, the lightfastness of an image formed on a recording medium can be reduced to cause, for example, discoloration. In the case where the proportion of the hydroxyphenyltriazine-based compound exceeds the range described above, the curing properties of an image formed on a recording medium can be impaired.

In the case where only the hindered amine-based compound is contained as the component (C), the proportion of the hindered amine-based compound is in the range of 0.2% by mass to 2.0% by mass with respect to the total mass of the photocurable ink composition. In the case where the proportion of the hindered amine-based compound is within the range described above, the curing of an image formed on a recording medium is not inhibited, and it is possible to reduce, for example, the discoloration of the image and the bleeding of the ultraviolet absorbent on the surface of the image when the image is stored for long periods. In the case where the proportion of the hindered amine-based compound is less than the range described above, the lightfastness of an image formed on a recording medium can be reduced to cause, for example, discoloration. In the case where the proportion of the hindered amine-based compound exceeds the range described above, the curing properties of an image formed on a recording medium can be reduced. Furthermore, the discoloration of the image and the bleeding of the light stabilizer on the surface of the image when the image is stored for long periods can be caused.

In the case where the hindered amine-based compound and the hydroxyphenyltriazine-based compound are contained as the component (C), the total proportion of the hindered amine-based compound and the hydroxyphenyltriazine-based compound is in the range of 0.2% by mass to 2.0% by mass with respect to the total mass of the photocurable ink composition. In the case where the total proportion of both compounds is within the range described above, the curing of an image formed on a recording medium is not inhibited, and it is possible to reduce, for example, the discoloration of the image and the bleeding of the ultraviolet absorbent and the light stabilizer on the surface of the image when the image is stored for long periods.

In the case where the total proportion of both compounds is less than the range described above, the lightfastness of an image formed on a recording medium can be reduced to cause, for example, discoloration. In the case where the total proportion of both compounds exceeds the range described above, the curing properties of an image formed on a recording medium can be reduced. Furthermore, the discoloration of the image and the bleeding of the ultraviolet absorbent and the light stabilizer on the surface of the image when the image is stored for long periods can be caused.

In the case where the photocurable ink composition according to this embodiment contains both the hydroxyphenyltriazine-based compound and the hindered amine-based compound, the ultraviolet-absorbing effect and the radical-trapping effect are complementarily provided to efficiently prevent the discoloration of an image formed on a recording medium.

In the case where the hindered amine-based compound and the hydroxyphenyltriazine-based compound are contained as the component (C), the ratio (WA/WB) of the proportion (WA) of the hydroxyphenyltriazine-based compound to the proportion (WB) of the hindered amine-based compound is preferably in the range of 0.2 to 5, more preferably 0.4 to 3, and particularly preferably 0.5 to 2. In the case where the ratio of the proportions of the compounds is within the range described above, the ultraviolet-absorbing effect and the radical-trapping effect are complementarily provided more easily.

In the case where the ratio of the proportions of the compounds is less than the range described above, the ultraviolet-absorbing effect is not easily provided. In the case where the ratio of the proportions of the compounds exceeds the range described above, the radical-trapping effect is not easily provided. Thus, the complementary effect of the ultraviolet-absorbing effect and the radical-trapping effect is not provided, in some cases.

### 1.4. Additional Additive

The photocurable ink composition according to this embodiment may contain an additive, for example, a pigment, a polymerization inhibitor, a dispersant, or a surfactant, as needed.

### 1.4.1. Pigment

While the photocurable ink composition according to this embodiment functions as what is called clear ink as it is, a pigment may be added thereto. Examples of the pigment that can be used in this embodiment include, but are not particularly limited to, inorganic pigments and organic pigments. Examples of the inorganic pigments that can be used include titanium oxide, iron oxide, and carbon black that is produced by a known method, for example, a contact method, a furnace method, or a thermal method. Examples of the organic pigments that can be used include azo pigments, such as azo lake pigments, insoluble azo pigments, condensed azo pigments, and chelate azo pigments; polycyclic pigments, such as phthalocyanine pigments, perylene pigments, perinone pigments, anthraquinone pigments, and quinophthalone pigments; nitro pigments; nitroso pigments; and aniline black.

Among these pigments that can be used in this embodiment, an example of carbon black is C.I. Pigment Black 7. Specific examples of C.I. Pigment Black 7 include No. 2300, No. 900, MCF88, No. 33, No. 40, No. 45, No. 52, MA7, MA8, MA100, and No. 2200B, which are available from Mitsubishi Chemical Corporation; Raven 5750, Raven 5250, Raven 5000, Raven 3500, Raven 1255, and Raven 700, which are available from Columbian Chemicals Company; Regal 400R, Regal 330R, Regal 660R, MogulL, MogulL 700, Monarch 800, Monarch 880, Monarch 900, Monarch 1000, Monarch 1100, Monarch 1300, and Monarch 1400, which are available from Cabot Corporation; and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4, which are available from Degussa.

Examples of the pigment that can be used when the photocurable ink composition according to this embodiment serves as a yellow ink include C.I. Pigment Yellows 1, 2, 3, 12, 13, 14, 16, 17, 73, 74, 75, 83, 93, 95, 97, 98, 109, 110, 114, 120, 128, 129, 138, 150, 151, 154, 155, 180, 185, and 213.

Examples of the pigment that can be used when the photocurable ink composition according to this embodiment serves as a magenta ink include C.I. Pigment Reds 5, 7, 12, 48 (Ca), 48 (Mn), 57 (Ca), 57:1, 112, 122, 123, 168, 184, 202, 209, and C.I. Pigment Violet 19.

Examples of the pigment that can be used when the photocurable ink composition according to this embodiment serves as a cyan ink include C.I. Pigment Blues 1, 2, 3, 15:3, 15:4, 16, 22, and 60.

The pigment that can be used in this embodiment preferably has an average particle size of 10 nm to 200 nm and more preferably 50 nm to 150 nm.

The amount of the pigment that can be added to the photocurable ink composition according to this embodiment is preferably in the range of 0.1 parts by mass to 25 parts by mass and more preferably 0.5 parts by mass to 15 parts by mass with respect to the total mass of the photocurable ink composition.

### 1.4.2. Polymerization Inhibitor

The photocurable ink composition according to this embodiment may contain a polymerization inhibitor in order to improve the storage stability. Any polymerization inhibitor may be used so long as it has the capability of trapping a radical to inhibit radical polymerization. Examples thereof include hydroquinones, catechols, and phenols.

Examples of hydroquinones include hydroquinone, hydroquinone monomethyl ether, 1-o-2,3,5-trimethylhydroquinone, and 2-tert-butylhydroquinone. Examples of catechols include catechol, 4-methylcatechol, and 4-tert-butylcatechol. Examples of phenols include phenol, butylhydroxytoluene, butylhydroxyanisole, and pyrogallol.

### 1.4.3. Dispersant

The photocurable ink composition according to this embodiment may contain a dispersant in order to enhance the dispersibility of the pigment. Examples of the dispersant that can be used in this embodiment include polymeric dispersants, such as Solsperse 3000, Solsperse 5000, Solsperse 9000, Solsperse 12000, Solsperse 13240, Solsperse 17000, Solsperse 24000, Solsperse 26000, Solsperse 28000, and Solsperse 36000 (manufactured by Lubrizol Corporation), Discol N-503, N-506, N-509, N-512, N-515, N-518, and N-520 (manufactured by Dai-ichi Kogyo Seiyaku Co., Ltd).

### 1.4.4. Surfactant

The photocurable ink composition according to this embodiment may contain a surfactant. The surfactant that can be used in this embodiment is preferably a silicone surfactant and more preferably a polyester-modified silicone or a polyether-modified silicone. Specific examples of the polyester-modified silicone include BYK-347, BYK-348, BYK-UV3500, BYK-UV3510, and BYK-UV3530 (manufactured by BYK Japan KK). Specific examples of the polyether-modified silicone include BYK-378 and BYK-3570 (manufactured by BYK Japan KK).

### 1.5. Physical Properties

### 1.5.1. Viscosity

The photocurable ink composition according to this embodiment preferably has a viscosity of 5 mPa·s to 50 mPa·s and more preferably 20 mPa·s to 40 mPa·s at 20° C. In the case where the viscosity of the photocurable ink composition at 20° C. is within the range described above, an appropriate amount of the photocurable ink composition is ejected from a nozzle, so that the deflection and scattering of the photocurable ink composition are further reduced. Thus, the photocurable ink composition can be suitably used for an ink jet recording apparatus. The viscosity was measured with a rheometer MCR-300 (manufactured by Physica) at 20° C. by increasing the shear rate from 10 to 1000 and reading a viscosity at a shear rate of 200.

### 1.5.2. Surface Tension

The photocurable ink composition according to this embodiment preferably has a surface tension of 20 mN/m to 30 mN/m at 20° C. In the case where the surface tension of the photocurable ink composition at 20° C. is within the range described above, the photocurable ink composition is less likely to wet a nozzle that has been subjected to lyophobic treatment. This results in the ejection of an appropriate amount of the photocurable ink composition from the nozzle and further reductions of the deflection and scattering of the photocurable ink composition. Thus, the photocurable ink composition can be suitably used for an ink jet recording apparatus. The surface tension was measured with an automatic surface tensiometer CBVP-Z (manufactured by Kyowa Interface Science Co., Ltd) by wetting a platinum plate with ink at 20° C. to determine the surface tension.

### 2. Ink Jet Recording Method and Recording Product

An ink jet recording method according to an embodiment of the invention includes ejecting the photocurable ink composition described above onto a recording medium, and irradiating the ejected photocurable ink composition with light having a peak emission wavelength of 350 nm to 430 nm from a light source.

The photocurable ink composition has been described above. Thus, the detailed description is omitted.

Examples of the recording medium include, but are not particularly limited to, media composed of plastics, such as polyvinyl chloride, polyethylene terephthalate, polypropylene, polyethylene, and polycarbonate; surface-treated media composed of the plastics; media composed of glass; and coated paper.

The ink jet recording method may be performed with, for example, an ink jet recording apparatus. An example of the ink jet recording apparatus is an ink jet printer. An example of the ink jet printer is a printer including an ink jet recording head, main body, a tray, a head-driving mechanism, a carriage, and a light-emitting unit mounted on a side of the carriage. The ink jet recording head includes, for example, ink cartridges of cyan, magenta, yellow, black, and so forth in such a manner that full-color printing can be performed. A cartridge of clear ink, which does not contain a pigment, may be added to the ink cartridges. Alternatively, any one of the ink cartridges may be replaced with the cartridge of clear ink.

The ink jet recording method using the ink jet printer is as follows: The charged photocurable ink composition is ejected from the ink jet recording head to attach the photocurable ink composition onto the recording medium, thereby forming an image. The ink jet printer includes a special control board therein to control the ejection timing of the ink from the ink jet recording head and the scanning of the head-driving mechanism. Any known method for ejecting ink may be employed. In particular, for a method for ejecting a droplet using the vibration of a piezoelectric element (a recording method using an ink jet head that forms an ink droplet by the mechanical deformation of an electrostrictive element), an excellent image recording can be performed.

Then the image is irradiated with light from the light-emitting unit to cure the photocurable ink composition. The light from a light source preferably has a peak emission wavelength of 350 nm to 430 nm and more preferably 380 nm to 400 nm.

Examples of the light source include a light-emitting diode (LED), a semiconductor laser diode (LD), a mercury lamp, a metal halide lamp, a xenon lamp, an excimer lamp. Among these light sources, the LED or LD is preferably used as the light source because it emits light having a wavelength of 350 nm to 430 nm without using a filter or the like. Furthermore, the use of the LED or LD as the light source circumvents an increase in the size of the light source due to the mounting of the filter compared with the case of using the mercury lamp, the metal halide lamp, or another lamp. Moreover, the use of the LED or LD as the light source eliminates a reduction in the intensity of light due to the absorption of the filter, thereby efficiently curing the photocurable ink composition.

The cumulative amount of light is preferably in the range of 10 mJ/cm² to 1000 mJ/cm² and more preferably 50 mJ/cm² to 500 mJ/cm². A cumulative amount of light within the range described above allows the photocurable ink composition to be sufficiently cured.

For the ink jet recording method according to an embodiment of the invention, the discoloration and the bleeding of the ultraviolet absorbent on the surface of the image when the image is stored for long periods can be reduced while the photocurable ink composition ejected on the recording medium is sufficiently cured.

A recording product according to an embodiment of the invention is a product recorded by the ink jet recording method. Thus, an image recorded on the recording medium has excellent curing properties, reduced discoloration, and reduced bleeding of the ultraviolet absorbent on the surface of the image when the image is stored for long periods.

### 3. Examples

While the invention will be specifically described by examples, the invention is not limited to the examples.

### 3.1. Preparation of Photocurable Ink Composition

A polymerizable compound, an acylphosphine oxide-based photopolymerization initiator, an ultraviolet absorbent, a hindered amine-based compound, and a polymerization inhibitor were mixed and completely dissolved in such a manner that each of the compositions described in Tables 1 to 3 was achieved.

Components shown in the tables are described below.

### (1) Polymerizable Compound

Phenoxy acrylate (trade name: D192, manufactured by Osaka

### Organic Chemical Industry Ltd.)

Tripropylene glycol diacrylate (trade name: APG200, manufactured by Shin Nakamura Chemical Co., Ltd.)

Tricyclodecanedimethanol diacrylate (trade name: KAYARAD R-684, manufactured by Nippon Kayaku Co., Ltd.)
(2) Acylphosphine Oxide-Based Photopolymerization Initiator IRGACURE 819 (manufactured by Ciba Japan K.K., bis(2,4,6-trimethylbenzoyl)phenylphosphine oxide)
DAROCUR TPO (manufactured by Ciba Japan K.K., 2,4,6-trimethylbenzoyldiphenylphosphine oxide)

### (3) Ultraviolet Absorbent

TINUVIN 479 (manufactured by Ciba Japan K.K., hydroxyphenyltriazine-based compound)
TINUVIN 120 (manufactured by Ciba Japan K.K., benzoate-based compound)

### (4) Light Stabilizer

CHIMASSORB 944FDL (manufactured by Ciba Japan K.K., mass-average molecular weight: 2000 to 3100)
TINUVIN 622LD (manufactured by Ciba Japan K.K., mass-average molecular weight: 3100 to 4000)
TINUVIN 123 (manufactured by Ciba Japan K.K., mass-average molecular weight: about 400)
ADK STAB LA-77 (manufactured by Asahi Denka Co., Ltd., mass-average molecular weight: about 500)

### (5) Polymerization Inhibitor

hydroquinone monomethyl ether (trade name: P-methoxyphenol, manufactured by Kanto Chemical Co., Inc.)

### (6) Surfactant

BYK-UV3500 (manufactured by BYK Japan KK)

### 3.2. Evaluation Test Using Photocurable Ink Composition

### 3.2.1. Production of Printed Article

The photocurable ink composition prepared in section “3.1. Preparation of Photocurable Ink Composition” was applied on a PET film with an ink jet printer PX-5000 (manufactured by Seiko Epson Corporation) at a resolution of 720×720 dpi and a droplet weight of 10 ng to form a solid pattern image. The solid pattern image was cured by irradiation with ultraviolet rays from an ultraviolet-emitting unit (UV-LED, peak emission wavelength: 395 nm, illuminance: 60 mW/cm²) mounted on a side of the carriage to produce a printed article. Note that the irradiation with ultraviolet rays was performed until the solid pattern image was dry to the touch.

### 3.2.2. Curing Test

The cumulative amount of ultraviolet rays needed for curing was determined by performing the irradiation until the solid pattern image was dry to the touch and measuring the cumulative amount of ultraviolet rays at that time with a light integrating meter UM-40 (manufactured by Konica Minolta Holdings, Inc).

Evaluation criteria are described below.

A: the cumulative amount of light is less than 500 mJ/cm²
B: the cumulative amount of light is 500 mJ/cm² or more and less than 1000 mJ/cm²
C: the cumulative amount of light is 1000 mJ/cm² or more

### 3.2.3. Bleeding Test

The printed article produced in section “3.2.1. Production of Printed Article” was allowed to stand for 30 days at a constant temperature of −5° C. and then 30 days at a constant temperature of 60° C. The resulting solid pattern image was visually observed to check the occurrence of bleeding on the surface.

Evaluation criteria are described below.

A: No bleeding occurs on the surface of the solid pattern image.
B: Bleeding occurs on the surface of the solid pattern image.

### 3.2.4. Lightfastness Test

A lightfastness test was performed by allowing the printed article produced in section “3.2.1. Production of Printed Article” to stand for 300 hours in a Xenon weathermeter XL-75 (manufactured by Suga Test Instruments Co., Ltd.) at a temperature of 63° C. and an illuminance of 70,000 lux. Then the values of a* and b* of the solid pattern image before and after the lightfastness test were measured with a colorimeter (trade name: Spectrolino, manufactured by Gretag-Macbeth AG). The value of ΔE (color difference) was calculated from expression (7) using the values of a* and b* to evaluate the discoloration before and after the lightfastness test.

ΔE=[(L₁−L₂)²+(a₁−a₂)²+(b₁−b₂)²]^{1/2} (7)

(wherein L₁, a₁, and b₁ represent the value of L*, the value of a*, and the value of b*, respectively, before the lightfastness test; and L₂, a₂, and b₂ represent the value of L*, the value of a*, and the value of b*, respectively, after the lightfastness test).

Evaluation criteria are described below.

A: the value of ΔE is less than 3.0
B: the value of ΔE is less than 6.0
C: the value of ΔE is 6.0 or more

### 3.3. Measurement of Absorption Spectra of Ultraviolet Absorbent and Polymerization Initiator

Among the materials described in section “3.1. Preparation of Photocurable Ink Composition”, IRGACURE 819 (acylphosphine oxide-based photopolymerization initiator), DAROCUR TPO (acylphosphine oxide-based photopolymerization initiator), and TINUVIN 479 (hydroxyphenyltriazine-based compound, ultraviolet absorbent) were selected. To easily detect maximum absorption spectra of the materials, these materials were diluted with a solvent (acetonitrile) in such a manner that the resulting solutions had concentrations described in (a) to (e). The maximum absorption spectra of the solutions (a) to (e) were measured in the range of about 350 nm to about 430 nm using a spectrophotometer U-3300 (manufactured by Hitachi High-Technologies Corporation).

(a) IRGACURE 819: 4.0×10⁻² percent by mass
(b) DAROCUR TPO: 4.8×10⁻² percent by mass
(c) TINUVIN 479: 0.75×10⁻² percent by mass
(d) TINUVIN 479: 0.15×10⁻² percent by mass
(e) Mixture of equal amounts of (a) and (b): 8.8×10⁻² percent by mass

### 3.4. Evaluation Results

Tables 1 to 3 show the evaluation results of the curing test, the bleeding test, and the lightfastness test. FIGURE shows the absorption spectra of the ultraviolet absorbent and the polymerization initiator.

TABLE 1

| | | | Exam- | Exam- | Exam- | Exam- | Exam- | Exam- | Exam- | Exam- |
|---|---|---|---|---|---|---|---|---|---|---|
| | | | ple 1 | ple 2 | ple 3 | ple 4 | ple 5 | ple 6 | ple 7 | ple 8 |
| Polymerizable compound (mass %) | | Phenoxyethyl acrylate | 62.0 | 61.2 | 60.2 | 62.0 | 61.2 | 60.2 | 62.0 | 61.2 |
| | | Tripropylene glycol | 15 | 15 | 15 | 15 | 15 | 15 | 15 | 15 |
| | | diacrylate | | | | | | | | |
| | | Tricyclodecanedimethanol | 15 | 15 | 15 | 15 | 15 | 15 | 15 | 15 |
| | | diacrylate | | | | | | | | |
| Acylphosphine oxide-based | | IRGACURE 819 | 3.5 | 3.5 | 3.5 | 3.5 | 3.5 | 3.5 | 3.5 | 3.5 |
| photopolymerization initiator | | DAROCUR TPO | 4.0 | 4.0 | 4.0 | 4.0 | 4.0 | 4.0 | 4.0 | 4.0 |
| (mass %) | | | | | | | | | | |
| Ultraviolet | Hydroxyphenyltriazine | TINUVIN 479 | 0.2 | 1.0 | 2.0 | | | | | |
| absorbent | Benzoate | TINUVIN 120 | | | | | | | | |
| (mass %) | | | | | | | | | | |
| Light | Weight-average | CHIMASSORB 944FDL | | | | 0.2 | 1.0 | 2.0 | | |
| stabilizer | molecular weight: | TINUVIN 622LD | | | | | | | 0.2 | 1.0 |
| (hindered | 2000 to 4000 | | | | | | | | | |
| amine- | Weight-average | TINUVIN 123 | | | | | | | | |
| based | molecular weight: | ADK STAB LA-77 | | | | | | | | |
| compound) | outside range above | | | | | | | | | |
| (mass %) | | | | | | | | | | |

| | | | | | | | | | |
|---|---|---|---|---|---|---|---|---|---|
| Polymerization inhibitor (mass %) | Hydroquinone monomethyl | 0.1 | 0.1 | 0.1 | 0.1 | 0.1 | 0.1 | 0.1 | 0.1 |
| | ether | | | | | | | | |
| Surfactant | BYK-UV3500 | 0.2 | 0.2 | 0.2 | 0.2 | 0.2 | 0.2 | 0.2 | 0.2 |
| Evaluation results | Curing test | A | A | B | B | B | B | B | B |
| | Bleeding test | B | B | B | B | B | B | B | B |
| | Lightfastness test | B | B | B | B | B | B | B | B |

| | | | Exam- | Exam- | Exam- | Exam- | Exam- | Exam- | Exam- |
|---|---|---|---|---|---|---|---|---|---|
| | | | ple 9 | ple 10 | ple 11 | ple 12 | ple 13 | ple 14 | ple 15 |
| Polymerizable compound (mass %) | | Phenoxyethyl acrylate | 60.2 | 62.0 | 61.2 | 60.2 | 62.0 | 61.2 | 60.2 |
| | | Tripropylene glycol | 15 | 15 | 15 | 15 | 15 | 15 | 15 |
| | | diacrylate | | | | | | | |
| | | Tricyclodecanedimethanol | 15 | 15 | 15 | 15 | 15 | 15 | 15 |
| | | diacrylate | | | | | | | |
| Acylphosphine oxide-based | | IRGACURE 819 | 3.5 | 3.5 | 3.5 | 3.5 | 3.5 | 3.5 | 3.5 |
| photopolymerization initiator | | DAROCUR TPO | 4.0 | 4.0 | 4.0 | 4.0 | 4.0 | 4.0 | 4.0 |
| (mass %) | | | | | | | | | |
| Ultraviolet | Hydroxyphenyltriazine | TINUVIN 479 | | 0.067 | 0.33 | 0.67 | 0.133 | 0.67 | 1.33 |
| absorbent | Benzoate | TINUVIN 120 | | | | | | | |
| (mass %) | | | | | | | | | |
| Light | Weight-average | CHIMASSORB 944FDL | | 0.133 | 0.67 | 1.33 | | | |
| stabilizer | molecular weight: | TINUVIN 622LD | 2.0 | | | | 0.067 | 0.33 | 0.67 |
| (hindered | 2000 to 4000 | | | | | | | | |
| amine- | Weight-average | TINUVIN 123 | | | | | | | |
| based | molecular weight: | ADK STAB LA-77 | | | | | | | |
| compound) | outside range above | | | | | | | | |
| (mass %) | | | | | | | | | |

| | | | | | | | | |
|---|---|---|---|---|---|---|---|---|
| Polymerization inhibitor (mass %) | Hydroquinone monomethyl | 0.1 | 0.1 | 0.1 | 0.1 | 0.1 | 0.1 | 0.1 |
| | ether | | | | | | | |
| Surfactant | BYK-UV3500 | 0.2 | 0.2 | 0.2 | 0.2 | 0.2 | 0.2 | 0.2 |
| Evaluation results | Curing test | B | B | B | B | B | B | B |
| | Bleeding test | B | B | B | B | B | B | B |
| | Lightfastness test | B | B | A | A | B | A | A |

TABLE 2

| | | | Compar- | Compar- | Compar- | Compar- | Compar- | Compar- | Compar- | Compar- |
|---|---|---|---|---|---|---|---|---|---|---|
| | | | ative ex- | ative ex- | ative ex- | ative ex- | ative ex- | ative ex- | ative ex- | ative ex- |
| | | | ample 1 | ample 2 | ample 3 | ample 4 | ample 5 | ample 6 | ample 7 | ample 8 |
| Polymerizable compound | | Phenoxyethyl | 62.2 | 62.1 | 62.0 | 61.2 | 60.2 | 59.7 | 62.1 | 62.0 |
| (mass %) | | acrylate | | | | | | | | |
| | | Tripropylene | 15 | 15 | 15 | 15 | 15 | 15 | 15 | 15 |
| | | glycol | | | | | | | | |
| | | diacrylate | | | | | | | | |
| | | Tricyclodecane- | 15 | 15 | 15 | 15 | 15 | 15 | 15 | 15 |
| | | dimethanol | | | | | | | | |
| | | diacrylate | | | | | | | | |
| Acylphosphine oxide-based | | IRGACURE 819 | 3.5 | 3.5 | 3.5 | 3.5 | 3.5 | 3.5 | 3.5 | 3.5 |
| photopolymerization | | DAROCUR TPO | 4.0 | 4.0 | 4.0 | 4.0 | 4.0 | 4.0 | 4.0 | 4.0 |
| initiator (mass %) | | | | | | | | | | |
| Ultraviolet | Hydroxyphenyl- | TINUVIN 479 | | | | | | | | |
| absorbent | triazine | | | | | | | | | |
| (mass %) | Benzoate | TINUVIN 120 | | 0.1 | 0.2 | 1.0 | 2.0 | 2.5 | | |
| Light | Weight-average | CHIMASSORB | | | | | | | | |
| stabilizer | molecular | 944FDL | | | | | | | | |
| (hindered | weight: 2000 | TINUVIN | | | | | | | | |
| amine-based | to 4000 | 622LD | | | | | | | | |
| compound) | Weight-average | TINUVIN 123 | | | | | | | 0.1 | 0.2 |
| (mass %) | molecular | ADK STAB | | | | | | | | |
| | weight: outside | LA-77 | | | | | | | | |
| | range above | | | | | | | | | |

| | | | | | | | | | |
|---|---|---|---|---|---|---|---|---|---|
| Polymerization inhibitor | Hydroquinone | 0.1 | 0.1 | 0.1 | 0.1 | 0.1 | 0.1 | 0.1 | 0.1 |
| (mass %) | monomethyl | | | | | | | | |
| | ether | | | | | | | | |
| Surfactant | BYK-UV3500 | 0.2 | 0.2 | 0.2 | 0.2 | 0.2 | 0.2 | 0.2 | 0.2 |
| Evaluation results | Curing test | A | A | A | A | B | C | A | A |
| | Bleeding test | — | B | B | C | C | C | B | B |
| | Lightfastness | C | C | C | C | C | C | C | C |
| | test | | | | | | | | |

| | | | Compar- | Compar- | Compar- | Compar- | Compar- | Compar- |
|---|---|---|---|---|---|---|---|---|
| | | | ative ex- | ative ex- | ative ex- | ative ex- | ative ex- | ative ex- |
| | | | ample 9 | ample 10 | ample 11 | ample 12 | ample 13 | ample 14 |
| Polymerizable compound | | Phenoxyethyl | 61.2 | 60.2 | 59.7 | 62.1 | 62.0 | 61.2 |
| (mass %) | | acrylate | | | | | | |
| | | Tripropylene | 15 | 15 | 15 | 15 | 15 | 15 |
| | | glycol | | | | | | |
| | | diacrylate | | | | | | |
| | | Tricyclodecane- | 15 | 15 | 15 | 15 | 15 | 15 |
| | | dimethanol | | | | | | |
| | | diacrylate | | | | | | |
| Acylphosphine oxide-based | | IRGACURE 819 | 3.5 | 3.5 | 3.5 | 3.5 | 3.5 | 3.5 |
| photopolymerization | | DAROCUR TPO | 4.0 | 4.0 | 4.0 | 4.0 | 4.0 | 4.0 |
| initiator (mass %) | | | | | | | | |
| Ultraviolet | Hydroxyphenyl- | TINUVIN 479 | | | | | | |
| absorbent | triazine | | | | | | | |
| (mass %) | Benzoate | TINUVIN 120 | | | | | | |
| Light | Weight-average | CHIMASSORB | | | | | | |
| stabilizer | molecular | 944FDL | | | | | | |
| (hindered | weight: 2000 to | TINUVIN | | | | | | |
| amine-based | 4000 | 622LD | | | | | | |
| compound) | Weight-average | TINUVIN 123 | 1.0 | 2.0 | 2.5 | | | |
| (mass %) | molecular | ADK STAB | | | | 0.1 | 0.2 | 1.0 |
| | weight: outside | LA-77 | | | | | | |
| | range above | | | | | | | |

| | | | | | | | |
|---|---|---|---|---|---|---|---|
| Polymerization inhibitor | Hydroquinone | 0.1 | 0.1 | 0.1 | 0.1 | 0.1 | 0.1 |
| (mass %) | monomethyl | | | | | | |
| | ether | | | | | | |
| Surfactant | BYK-UV3500 | 0.2 | 0.2 | 0.2 | 0.2 | 0.2 | 0.2 |
| Evaluation results | Curing test | A | B | C | A | A | A |
| | Bleeding test | C | C | C | B | B | C |
| | Lightfastness | C | C | C | C | C | C |
| | test | | | | | | |

TABLE 3

| | | | Compar- | Compar- | Compar- | Compar- | Compar- | Compar- | Compar- |
|---|---|---|---|---|---|---|---|---|---|
| | | | ative ex- | ative ex- | ative ex- | ative ex- | ative ex- | ative ex- | ative ex- |
| | | | ample 15 | ample 16 | ample 17 | ample 18 | ample 19 | ample 20 | ample 21 |
| Polymerizable compound | | Phenoxyethyl | 60.2 | 59.7 | 62.1 | 59.7 | 62.1 | 59.7 | 62.1 |
| (mass %) | | acrylate | | | | | | | |
| | | Tripropylene | 15 | 15 | 15 | 15 | 15 | 15 | 15 |
| | | glycol | | | | | | | |
| | | diacrylate | | | | | | | |
| | | Tricyclodecane- | 15 | 15 | 15 | 15 | 15 | 15 | 15 |
| | | dimethanol | | | | | | | |
| | | diacrylate | | | | | | | |
| Acylphosphine oxide-based | | IRGACURE 819 | 3.5 | 3.5 | 3.5 | 3.5 | 3.5 | 3.5 | 3.5 |
| photopolymerization initiator | | DAROCUR TPO | 4.0 | 4.0 | 4.0 | 4.0 | 4.0 | 4.0 | 4.0 |
| (mass %) | | | | | | | | | |
| Ultraviolet | Hydroxyphenyl- | TINUVIN 479 | | | 0.1 | 2.5 | | | |
| absorbent | triazine | | | | | | | | |
| (mass %) | Benzoate | TINUVIN 120 | | | | | | | |
| Light | Weight-average | CHIMASSORB | | | | | 0.1 | 2.5 | |
| stabilizer | molecular | 944FDL | | | | | | | |
| (hindered | weight: 2000 to | TINUVIN | | | | | | | 0.1 |
| amine-based | 4000 | 622LD | | | | | | | |
| compound) | Weight-average | TINUVIN 123 | | | | | | | |
| (mass %) | molecular | ADK STAB | 2.0 | 2.5 | | | | | |
| | weight: outside | LA-77 | | | | | | | |
| | range above | | | | | | | | |

| | | | | | | | | |
|---|---|---|---|---|---|---|---|---|
| Polymerization inhibitor | Hydroquinone | 0.1 | 0.1 | 0.1 | 0.1 | 0.1 | 0.1 | 0.1 |
| (mass %) | monomethyl | | | | | | | |
| | ether | | | | | | | |
| Surfactant | BYK-UV3500 | 0.2 | 0.2 | 0.2 | 0.2 | 0.2 | 0.2 | 0.2 |
| Evaluation results | Curing test | B | C | A | C | A | C | A |
| | Bleeding test | C | C | B | B | A | C | A |
| | Lightfastness | C | C | C | B | C | C | C |
| | test | | | | | | | |

| | | | Compar- | Compar- | Compar- | Compar- | Compar- |
|---|---|---|---|---|---|---|---|
| | | | ative ex- | ative ex- | ative ex- | ative ex- | ative ex- |
| | | | ample 22 | ample 23 | ample 24 | ample 25 | ample 26 |
| Polymerizable compound | | Phenoxyethyl | 59.7 | 62.1 | 59.7 | 62.1 | 59.7 |
| (mass %) | | acrylate | | | | | |
| | | Tripropylene | 15 | 15 | 15 | 15 | 15 |
| | | glycol | | | | | |
| | | diacrylate | | | | | |
| | | Tricyclodecane- | 15 | 15 | 15 | 15 | 15 |
| | | dimethanol | | | | | |
| | | diacrylate | | | | | |
| Acylphosphine oxide-based | | IRGACURE 819 | 3.5 | 3.5 | 3.5 | 3.5 | 3.5 |
| photopolymerization | | DAROCUR TPO | 4.0 | 4.0 | 4.0 | 4.0 | 4.0 |
| initiator (mass %) | | | | | | | |
| Ultraviolet | Hydroxyphenyl- | TINUVIN 479 | | 0.033 | 0.83 | 0.067 | 1.67 |
| absorbent | triazine | | | | | | |
| (mass %) | Benzoate | TINUVIN 120 | | | | | |
| Light | Weight-average | CHIMASSORB | | 0.067 | 1.67 | | |
| stabilizer | molecular | 944FDL | | | | | |
| (hindered | weight: 2000 to | TINUVIN | 2.5 | | | 0.033 | 0.83 |
| amine-based | 4000 | 622LD | | | | | |
| compound) | Weight-average | TINUVIN 123 | | | | | |
| (mass %) | molecular | ADK STAB | | | | | |
| | weight: outside | LA-77 | | | | | |
| | range above | | | | | | |

| | | | | | | |
|---|---|---|---|---|---|---|
| Polymerization inhibitor | Hydroquinone | 0.1 | 0.1 | 0.1 | 0.1 | 0.1 |
| (mass %) | monomethyl | | | | | |
| | ether | | | | | |
| Surfactant | BYK-UV3500 | 0.2 | 0.2 | 0.2 | 0.2 | 0.2 |
| Evaluation results | Curing test | C | A | C | A | C |
| | Bleeding test | C | A | C | A | C |
| | Lightfastness | C | C | A | C | A |
| | test | | | | | |

For the photocurable ink compositions of Examples 1 to 15 described in Table 1, the results of the curing test demonstrated that all image are cured at a low energy and that the photocurable ink compositions have excellent curing properties. The results of the bleeding test demonstrated that all images have satisfactory surface states without bleeding. The results of the lightfastness test demonstrated that all images are subjected to less discoloration by irradiation with light and that all images thus have excellent lightfastness.

The results illustrated in FIGURE demonstrated that the ultraviolet absorbent (TINUVIN 479) used in examples does not have a maximum absorption wavelength in the range of 350 nm to 430 nm and, in particular, only slightly absorbs light having a wavelength of about 395 nm, which is the peak emission wavelength of light from the ultraviolet LED. FIGURE also demonstrated that the acylphosphine oxide-based photopolymerization initiators (IRGACURE 819 and DAROCUR TPO) have maximum absorption wavelengths of 350 nm to 430 nm and sufficiently absorb light having a wavelength of about 395 nm, which is the peak emission wavelength of light from the ultraviolet LED. That is, even when the photocurable ink composition containing these compounds is irradiated with light having a wavelength of about 395 nm, which is the peak emission wavelength of light from the ultraviolet LED, the energy of light used for the cleavage of the acylphosphine oxide-based photopolymerization initiator (IRGACURE 819 or DAROCUR TPO) is rarely consumed by the ultraviolet absorbent (TINUVIN 479).

The photocurable ink composition of Comparative Example 1 shown in Table 2 does not contain the hydroxyphenyltriazine-based compound or the hindered amine-based compound, thereby providing an image having poor lightfastness. It is believed that the hydroxyphenyltriazine-based compound, the hindered amine-based compound, and so forth participate in the occurrence of bleeding on the surface of the image. Thus, for Comparative Example 1, in which these compounds are not contained, the bleeding test was not performed.

The photocurable ink compositions of Comparative Examples 2 to 6 shown in Table 2 do not contain the hydroxyphenyltriazine-based compound or the hindered amine-based compound, thereby providing images having poor lightfastness. Furthermore, the photocurable ink compositions of Comparative Examples 4 to 6 provided images on which bleeding occurred on the surfaces. The photocurable ink composition of Comparative Example 6 provided an image having poor curing properties.

The photocurable ink compositions of Comparative Examples 7 to 11 shown in Table 2 do not contain the hindered amine-based compound having a mass-average molecular weight of 2000 to 4000, thereby providing images having poor lightfastness. Furthermore, the photocurable ink compositions of Comparative Examples 9 to 11 provided images on which bleeding occurred on the surfaces. The photocurable ink composition of Comparative Example 11 provided an image having poor curing properties.

The photocurable ink compositions of Comparative Examples 12 to 16 shown in Tables 2 and 3 do not contain the hindered amine-based compound having a mass-average molecular weight of 2000 to 4000, thereby providing images having poor lightfastness. Furthermore, the photocurable ink compositions of Comparative Examples 14 to 16 provided images on which bleeding occurred on the surfaces. The photocurable ink composition of Comparative Example 16 provided an image having poor curing properties.

The photocurable ink composition of Comparative Example 17 shown in Table 3 contains the hydroxyphenyltriazine-based compound. However, the proportion of the hydroxyphenyltriazine-based compound is outside the range of 0.2% by mass to 2.0% by mass, thereby providing an image having poor lightfastness.

The photocurable ink composition of Comparative Example 18 shown in Table 3 contains the hydroxyphenyltriazine-based compound. However, the proportion of the hydroxyphenyltriazine-based compound is outside the range of 0.2% by mass to 2.0% by mass, thereby providing an image having poor lightfastness.

The photocurable ink composition of Comparative Example 19 shown in Table 3 contains the hindered amine-based compound having a mass-average molecular weight of 2000 to 4000. However, the proportion of the hindered amine-based compound is outside the range of 0.2% by mass to 2.0% by mass, thereby providing an image having poor lightfastness.

The photocurable ink composition of Comparative Example 20 shown in Table 3 contains the hindered amine-based compound having a mass-average molecular weight of 2000 to 4000. However, the proportion of the hindered amine-based compound is outside the range of 0.2% by mass to 2.0% by mass, thereby providing an image having poor lightfastness and poor curing properties.

The photocurable ink composition of Comparative Example 21 shown in Table 3 contains the hindered amine-based compound having a mass-average molecular weight of 2000 to 4000. However, the proportion of the hindered amine-based compound is outside the range of 0.2% by mass to 2.0% by mass, thereby providing an image having poor lightfastness.

The photocurable ink composition of Comparative Example 22 shown in Table 3 contains the hindered amine-based compound having a mass-average molecular weight of 2000 to 4000. However, the proportion of the hindered amine-based compound is outside the range of 0.2% by mass to 2.0% by mass, thereby providing an image having poor lightfastness and poor curing properties.

The photocurable ink composition of Comparative Example 23 shown in Table 3 contains the hydroxyphenyltriazine-based compound and the hindered amine-based compound having a mass-average molecular weight of 2000 to 4000. However, the total proportion thereof is outside the range of 0.2% by mass to 2.0% by mass, thereby providing an image having poor lightfastness.

The photocurable ink composition of Comparative Example 24 shown in Table 3 contains the hydroxyphenyltriazine-based compound and the hindered amine-based compound having a mass-average molecular weight of 2000 to 4000. However, the total proportion thereof is outside the range of 0.2% by mass to 2.0% by mass. Thus, bleeding occurred, and an image having poor curing properties was recorded.

The photocurable ink composition of Comparative Example 25 shown in Table 3 contains the hydroxyphenyltriazine-based compound and the hindered amine-based compound having a mass-average molecular weight of 2000 to 4000. However, the total proportion thereof is outside the range of 0.2% by mass to 2.0% by mass, thereby providing an image having poor lightfastness.

The photocurable ink composition of Comparative Example 26 shown in Table 3 contains the hydroxyphenyltriazine-based compound and the hindered amine-based compound having a mass-average molecular weight of 2000 to 4000. However, the total proportion thereof is outside the range of 0.2% by mass to 2.0% by mass. Thus, bleeding occurred, and an image having poor curing properties was recorded.

The invention is not limited to the foregoing embodiments. Various changes can be made. For example, the invention includes configurations substantially the same as those described in the embodiments (for example, a configuration with the same function, method, and result, or a configuration with the same object and effect). The invention also includes configurations in which portions not essential in the configurations described in the embodiments are replaced with others. The invention includes configurations that achieve the same functions and effects or achieve the same objects of those of the compositions described in the embodiments. Furthermore, the invention includes configurations in which known techniques are added to the configurations described in the embodiments.

What is claimed is:

1. A photocurable ink composition comprising:
(A) a polymerizable compound;
(B) an acylphosphine oxide-based photopolymerization initiator; and
(C) at least one compound selected from a hindered amine-based compound with a mass-average molecular weight of 2000 to 4000 and a hydroxyphenyltriazine-based compound of formula (1): 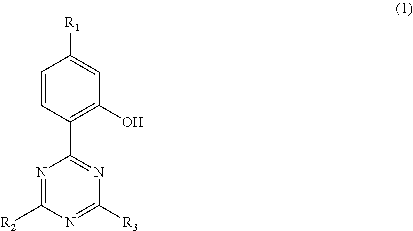
(wherein R₁, R₂, and R₃ each independently represent an organic group),
wherein the proportion of the component (C) is in the range of 0.2% by mass to 2.0% by mass.

2. The photocurable ink composition according to claim 1, wherein the acylphosphine oxide-based photopolymerization initiator has a molar absorption coefficient of 300 or more at 365 nm.

3. The photocurable ink composition according to claim 1, wherein the hydroxyphenyltriazine-based compound of formula (1) does not have a maximum absorption wavelength in the range of 350 nm to 430 nm,
the acylphosphine oxide-based photopolymerization initiator has a maximum absorption wavelength of 350 nm to 430 nm, and
the photocurable ink composition is cured by irradiation with light having a peak emission wavelength of 350 nm to 430 nm.

4. The photocurable ink composition according to claim 1, wherein the polymerizable compound contains at least one selected from phenoxyethyl acrylate, alkylene glycol diacrylate, and diacrylate having a alicyclic structure.

5. The photocurable ink composition according to claim 1, wherein the acylphosphine oxide-based photopolymerization initiator has at least one of a phenyl group and benzoyl group in its molecule.

6. The photocurable ink composition according to claim 5, wherein the acylphosphine oxide-based photopolymerization initiator is at least one selected from 2,4,6-trimethylbenzoyldiphenylphosphine oxide and bis(2,4,6-trimethylbenzoyl)phenylphosphine oxide.

7. The photocurable ink composition according to claim 1, wherein the acylphosphine oxide-based photopolymerization initiator content is in the range of 3% by mass to 15% by mass.

8. The photocurable ink composition according to claim 1, wherein the polymerizable compound content is 20% by mass or more.

9. An ink jet recording method comprising:
ejecting the photocurable ink composition according to claim 1 onto a recording medium; and
irradiating the ejected photocurable ink composition with light having a peak emission wavelength of 350 nm to 430 nm from a light source.

10. An ink jet recording method comprising:
ejecting the photocurable ink composition according to claim 2 onto a recording medium; and
irradiating the ejected photocurable ink composition with light having a peak emission wavelength of 350 nm to 430 nm from a light source.

11. An ink jet recording method comprising:
ejecting the photocurable ink composition according to claim 3 onto a recording medium; and
irradiating the ejected photocurable ink composition with light having a peak emission wavelength of 350 nm to 430 nm from a light source.

12. An ink jet recording method comprising:
ejecting the photocurable ink composition according to claim 4 onto a recording medium; and
irradiating the ejected photocurable ink composition with light having a peak emission wavelength of 350 nm to 430 nm from a light source.

13. An ink jet recording method comprising:
ejecting the photocurable ink composition according to claim 5 onto a recording medium; and
irradiating the ejected photocurable ink composition with light having a peak emission wavelength of 350 nm to 430 nm from a light source.

14. An ink jet recording method comprising:
ejecting the photocurable ink composition according to claim 6 onto a recording medium; and
irradiating the ejected photocurable ink composition with light having a peak emission wavelength of 350 nm to 430 nm from a light source.

15. An ink jet recording method comprising:
ejecting the photocurable ink composition according to claim 7 onto a recording medium; and
irradiating the ejected photocurable ink composition with light having a peak emission wavelength of 350 nm to 430 nm from a light source.

16. An ink jet recording method comprising:
ejecting the photocurable ink composition according to claim 8 onto a recording medium; and
irradiating the ejected photocurable ink composition with light having a peak emission wavelength of 350 nm to 430 nm from a light source.
